(19) United States
(12) Patent Application Publication
(10) Pub. No.: US 2007/0071066 A1
(43) Pub. Date: Mar. 29, 2007

(54) Infrared clinical thermometer device

(76) Inventors: Vincent Weng, HsinChu (TW); James Huang, HsinChu (TW); Jason Liao, HsinChu (TW); Joy Liao, HsinChu (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/605,314

(22) Filed: Nov. 29, 2006

(30) Foreign Application Priority Data
Sep. 12, 2005 (TW) 94143632

(51) Int. Cl. G01K 7/00

(52) U.S. Cl. 374/163

(57) ABSTRACT

The present invention discloses an infrared clinical thermometer device, wherein the ear thermometer casing has at least three light indicators; according to the measured temperature value, the microprocessor inside the casing generates a control signal and outputs the control signal to one of the light indicators; the control signal enables the light indicator to emit light to indicate to the user the state of the measured body temperature. In the present invention, light of different colors are used to indicate to the user the state of the measured body temperature; thus, the user can learn whether the body temperature is in the health state or in a fever state without watching the display but directly from the color of the emitted light; therefore, the operational convenience is greatly promoted. Further, in the present invention, a light source can be arranged beside the display, and the light source can emit a flickering light or a light of a specific color to illuminate the display to make the user read the measured temperature value easily; besides, the user can learn the state of the body temperature directly from the color of the light.

### BACKGROUND OF THE INVENTION

1. Field of the Invention

The present invention relates to an infrared clinical thermometer device, particularly to an infrared clinical thermometer device, which emits lights according to the states of the measured body temperatures.

1. Description of the Related Art

With the advance of science and technology, the clinical temperature has evolved from the traditional mercurial clinical thermometer to various electronic clinical thermometers. Among those electronic clinical thermometers, the ear thermometer is the most popular one. In principle, the ear thermometer utilizes infrared light to scan the thermal radiation released by the eardrum. The eardrum is located inside the skull and near the hypothalamus—the thermoregulation center in the brain, and both share the blood supplied by the carotid artery. Therefore, the eardrum can instantly reflect the variation of core body temperature. Thus, the body temperature can be obtained via receiving the infrared light reflected from the eardrum.

The current ear thermometer presents the measured temperature on a liquid crystal display and also generates an audio signal with a buzzer to indicate to the user that the body temperature is in a fever state. Besides, audio signals may also be used in the programming and reminding of the time of temperature measurement. A Taiwan patent No. 414323 proposed an “Ear Thermometer Structure with Reminding Function”, wherein the next measurement time can be preset; once it reaches the preset measurement time, the ear thermometer reminds the user to perform measurement with an audio signal.

Hospitals and wards are the places where the ear thermometer is used most frequently. When a nurse performs a temperature measurement, she extends the probe of the ear thermometer into the ear canal of the patient and presses the button, and the probe of the ear thermometer stays in the ear canal until the ear thermometer generates an audio signal indicating that the measurement is completed. The nurse learns whether the patient body temperature is normal from the temperature value presented on the display of the ear thermometer and then records it. As the ear thermometer is very close to the patient ear, the sound generated by the ear thermometer is in fact a noise for the patient. Besides, as the nurse has to read the measured temperature value presented on the display with a sufficient illumination, she has to turn on the lights of the ward, and the rest or sleep of other patients is thus disturbed.

Accordingly, the present invention proposes an infrared clinical thermometer device, which can emit lights of specified colors according to the states of the body temperatures, to overcome the problems of the conventional ear thermometer.

### SUMMARY OF THE INVENTION

The primary objective of the present invention is to provide an infrared clinical thermometer device, which indicates to the user the state of the body temperature not with the conventional audio mode but with lights to avoid noise.

Another objective of the present invention is to provide an infrared clinical thermometer device, wherein lights of different colors are emitted to indicate to the user the state of the measured body temperature; thus, the user can learn whether the body temperature is in the normal state or in a fever state directly from the color of the light; thereby, the operational convenience is greatly promoted.

Further objective of the present invention is to provide an infrared clinical thermometer device, wherein a light source is arranged beside the display and emits a flickering light or a light of a specific color to illuminate the display after a temperature measurement; thereby, the user can still read the measurement result easily even under a dim lighting condition and can learn the state of the body temperature directly from the color of the light.

According to one aspect, the infrared clinical thermometer device of the present invention comprises: a microprocessor and a sensor, which are arranged inside an ear thermometer casing; the sensor detects body temperature and generates a temperature signal, and the microprocessor processes the temperature signal and converts the temperature signal into a measured temperature value; the ear thermometer casing has at least three light indicators; according to the measured temperature value, the microprocessor generates a control signal and outputs the control signal to one of the light indicators, and the light indicator receiving the control signal emits light to indicate to the user the state of the measured body temperature. Besides, a color of light emitted by each of the light indicators is different.

To enable the objectives, technical contents, characteristics and accomplishments of the present invention to be easily understood, the embodiments of the present invention are to be described in detail in cooperation with the attached drawings below.

### BRIEF DESCRIPTION OF THE DRAWINGS

FIG. 1 is a block diagram schematically showing the circuit of the infrared clinical thermometer device according to the present invention;

FIG. 2 is a diagram schematically showing a first embodiment of the present invention; and

FIG. 3 is a diagram schematically showing a second embodiment of the present invention.

### DETAILED DESCRIPTION OF THE INVENTION

The present invention pertains to an infrared clinical thermometer device, which has a light indicator emitting a colored light to indicate to the user the state of the measured body temperature so that the user can learn the measurement result directly from the color of the emitted light without the disturbance of the noise generated by the conventional ear thermometer.

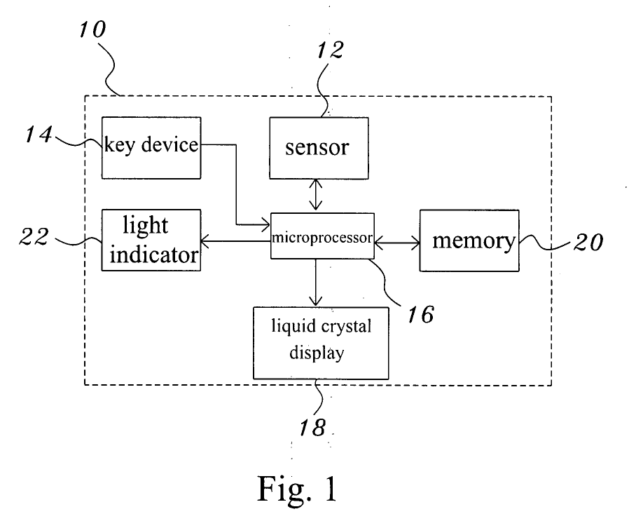

In the present invention, the infrared clinical thermometer device can be a forehead thermometer or an ear thermometer. In the embodiments to be described below, ear thermometers are used to exemplify the present invention. Refer to FIG. 1. The infrared clinical thermometer device comprises an ear thermometer casing 10 having a sensor 12 and a key device 14. The key device 14 connects with a microprocessor 16, and the microprocessor 16 connects with a liquid crystal display 18, a memory 20 and a light indicator 22. The memory 20 can be a RAM (Random Access Memory) or an EEPROM (Electrically Erasable Programmable Read Only Memory), and the memory 20 stores basal body temperature data, temperature-compensation parameters and operation programs thereinside.

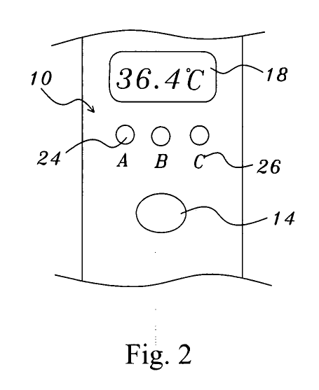

Below are to be described two embodiments, which are different in the configurations of the light indicators. Refer to FIG. 2 for a first embodiment. In the first embodiment, the light indicator 22 includes three light-emitting elements 24, which are arranged on the surface of the thermometer casing 20. The light-emitting elements 24 can be light-emitting diodes or light bulbs and respectively emit lights of different colors, such as red, green and yellow lights. Three different indication marks 26, such as Fever, Near Fever and Health, are respectively arranged on the surface of the ear thermometer casing 20 and near those three light-emitting elements 24.

When the user presses the key device 14, the sensor 12 detects body temperature and outputs a temperature signal to the microprocessor 16. The microprocessor 16 digitizes the temperature signal and compares the digitized temperature signal with the data stored in the memory 20 to generate a measured temperature value and a control signal. The measured temperature value is transferred to the liquid crystal display 16 and presented thereon, and the control signal is transferred to the light indicator 22 to enable a corresponding light-emitting element 26 to emit light. When the light-emitting element 24 emits light, the user will be attracted to notice the corresponding indication mark 26.

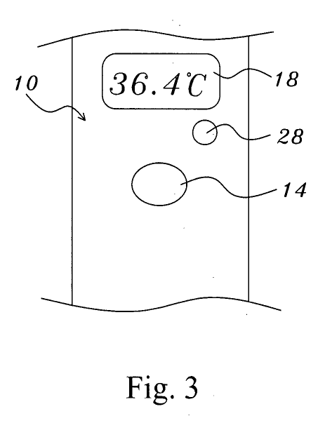

Refer to FIG. 1 and FIG. 3 for a second embodiment. In the second embodiment, the light indicator 22 is a multiple light-emitting element 28 composed of three light-emitting diodes, which respectively emit lights of different colors. In the second embodiment, there is no indication mark 26 arranged on the ear thermometer casing 10. The information that the lighting of the light indicator 22 intends to indicate is provided in the user's manual; for example, a red light indicates a sever fever, a yellow light indicates a slight fever, and a green light indicates the health state. When the light indicator 22 receives the control signal, the corresponding light-emitting diode will emit light to attract the notice of the user.

In contrast to the conventional ear thermometer that notifies the user with an audio signal, the infrared clinical thermometer device of the present invention notifies the user with a light and without any noise. Further, the infrared clinical thermometer device of the present invention indicates to the user the state of the measured body temperature with the lights of different colors; thus, the user can learn whether the body temperature is in the health state or in a fever state directly from the color of the light; therefore, the operational convenience is greatly promoted. Besides, in the present invention, a light source may be used to emit a flickering light or a light of a specific color to illuminate the display so that the user can read the measured temperature easily under a dim lighting condition and can learn the state of the body temperature directly from the color of the light.

Those described above are the embodiments to exemplify the present invention to enable the persons skilled in the art to understand, make, and use the present invention. However, it is not intended to limit the scope of the present invention. Any equivalent modification and variation according to the spirit of the present invention is to be also included within the scope of the claims of the present invention stated below.

What is claimed is:

1. An infrared clinical thermometer device, comprising: a casing; a sensor arranged inside said casing and used to detect body temperature and generate a temperature signal; and a microprocessor arranged inside said casing and used to process said temperature signal and convert said temperature signal into a measured temperature value, and characterized in:
said infrared clinical thermometer device further comprises at least three light indicators; said microprocessor generates a control signal according to said measured temperature value and outputs said control signal to one of said three light indicators, and the light indicator receiving said control signal thus emits light to indicate to the user the state of said measured temperature value; and
wherein a color of light emitted by each of said three light indicators is different.

2. The infrared clinical thermometer device according to claim 1, further comprising a memory storing basal body temperature data, temperature-compensation parameters, and operation programs.

3. The infrared clinical thermometer device according to claim 2, wherein said memory is a RAM (Random Access Memory) or an EEPROM (Electrically Erasable Programmable Read Only Memory).

4. The infrared clinical thermometer device according to claim 2, wherein said microprocessor digitizes said temperature signal and compares the digitized temperature signal with the data stored in said memory to generate said measured temperature value.

5. The infrared clinical thermometer device according to claim 1, further comprising a liquid crystal display used to present said measured temperature value.

6. The infrared clinical thermometer device according to claim 1, wherein said light indicator is a light-emitting diode or a light bulb.

7. The infrared clinical thermometer device according to claim 1, wherein indication marks are respectively arranged on the surface of said casing and near said three light indicators; after one of said three light indicators receive said control signal, the light indicator emits light to make the user notice the corresponding indication mark.

8. The infrared clinical thermometer device according to claim 7, wherein said indication marks include: the marks for fever, near fever and health.

9. The infrared clinical thermometer device according to claim 1, which is a forehead thermometer or an ear thermometer.
